(19) United States
(12) Patent Application Publication
(10) Pub. No.: US 2015/0262102 A1
(43) Pub. Date: Sep. 17, 2015

(54) CLOUD-BASED DATA PROCESSING IN ROBOTIC DEVICE

(71) Applicant: Evan Tann, Manitou Beach, MI (US)

(72) Inventor: Evan Tann, Manitou Beach, MI (US)

(73) Assignee: Evan Tann, Manitou Beach, MI (US)

(21) Appl. No.: 14/639,139

(22) Filed: Mar. 5, 2015

Related U.S. Application Data
(60) Provisional application No. 61/949,020, filed on Mar. 6, 2014.

(51) Int. Cl. G06Q 10/06; H04L 29/08

(52) U.S. Cl. CPC G06Q 10/06311; H04L 67/10

(57) ABSTRACT

According to embodiments of the present invention, a computer-implemented method for deriving a robotic action from data measurements received from a robotic device is presented. The method may include sensing first information from one or more sensors in the robotic device, transmitting the first information from the robotic computing device to a computing device and receiving processed information from the computing device. The processed information includes a hardware instruction to be performed by the robotic device. The robotic device performs an action based on the hardware instruction and stores the action. In some embodiments, the robotic device updates a training dataset based on the action. The training dataset may include past data inputs and/or training data associated with the robotic device. In certain embodiments, the robotic device may communicate feedback to the computing device that the action was performed successfully. In one embodiment, the robotic device may also communicate an updated training dataset to the computing device. In some embodiments, the computing device may then communicate the feedback of the action and the updated training dataset to one or more additional robotic devices. The action and the updated training dataset may be stored in the additional robotic devices.

### CROSS REFERENCE TO RELATED APPLICATIONS

This application claims the benefit of U.S. provisional patent application No. 61/949,020, filed on Mar. 6, 2014, the entire disclosure of which is hereby incorporated by reference in its entirety as if set forth verbatim herein and relied upon for all purposes.

### BACKGROUND

The present invention relates generally to a method and system for processing data related to robotic devices, and more particularly to a method and system for the centralized data processing of robotic devices.

Robots typically include a variety of sensors and data input devices. This data may include global positioning system (GPS) location data, mobile cell phone tower location data, acceleration data, distance measurements, ambient light inputs, video inputs, audio inputs, button inputs, information about other devices in the vicinity of the robot such as radio-frequency identification (RFID) signals, and the like.

Data processing in robots may be performed in a centralized manner to potentially reduce the on-board battery requirements, weight, cost, and complexity of robots. Such centralized data processing may typically be performed in a cloud computing environment. Centralized data processing may involve the analysis of data related to robots to determine actions performed by robots. Data related to robots may include past data derived from environmental inputs received from robots, such as a distance of the robot to a wall. Such data may also include user-based inputs, such as positive feedback communicated through a button press or contextual inputs, such as the time of day.

Creating and refining data related to robots has traditionally been a process unique to the robotic hardware design requirements of each individual robot. Creating and refining robotic data may require considerable amounts of time, data, and processing requirements. In addition, the large costs and complexity associated with training individual robots may impact the development of robotic artificial intelligence research and applications.

### BRIEF DESCRIPTION OF THE DRAWINGS

FIG. 1 is an illustrative system or architecture depicting one or more robotic devices interacting with a cloud computing system, in accordance with one embodiment of the present invention.

FIG. 2 depicts an example sequence diagram of the steps performed by the cloud computing system to communicate feedback of an action performed by one or more robotic devices, in accordance with one embodiment of the present invention.

FIG. 3 is a simplified block diagram of a robotic device, in accordance with one embodiment of the present invention.

FIG. 4 is a simplified block diagram of a cloud network linked to the robotic-computing device represented in FIG. 3, in accordance with one embodiment of the present invention.

FIG. 5 depicts a simplified block diagram of a computer system that may incorporate embodiments of the present invention.

### DETAILED DESCRIPTION

In accordance with at least one embodiment of the present invention, a computer-implemented method for determining one or more actions intended for use in robotic devices is disclosed. In one embodiment, a cloud computing system is disclosed. The cloud computing system receives sensor data measurements from one or more robotic devices, processes the data measurements, generates one or more hardware instructions based on the processed data measurements and transmits the hardware instructions to the robotic devices.

In some embodiments, the robotic devices may perform one or more actions based on the hardware instructions transmitted by the cloud computing system. As an example, an action performed by a robotic device may include pushing a heavy block with the cooperation of two, unique robotic devices, applying a greater voltage to a pin in the robotic device, and the like.

In some embodiments, a first robotic device may communicate feedback regarding a performed action to the cloud computing system. The cloud computing system may communicate this feedback to one or more additional robotic devices that are different from the first robotic device. Thus, in some embodiments, the cloud computing system may enable the coordination of actions between the robotic devices to accomplish a single goal.

In one embodiment, the performed actions may be stored as training data in the robotic devices. In some embodiments, the robotic devices may be configured to update their respective training datasets to include these stored actions. Thus, in some embodiments, data (i.e., feedback) transmitted from a robotic device to the cloud computing system may be used to further modify or refine training datasets and/or statistical models through which the robotic device may decide on an appropriate hardware-based action to perform. In some embodiments, training data sets may be shared between two or more robotic devices, regardless of their individual hardware configurations.

In one embodiment, processing of data related to robotic devices may occur in the cloud computing system. In other embodiments, the processing of data may occur onboard the robotic device, and the processed results may then be transmitted to the cloud computing system. After transmission, the data may be saved to hard drives, solid state drives, random access memory (RAM) or other data storage hardware, whether stored long-term or cached in the cloud computing system for any length of time, including momentary and permanent storage.

In one embodiment, the cloud computing system may include one or more computers or servers that store and optionally process data related to the robotic devices. In some embodiments, the computers or servers may be located on-board the robotic devices, on-site or within the same facility as the robotic devices, in the vicinity of the robotic devices or at other locations. In situations where the computers or servers are not physically attached to (i.e. on-board) the robotic devices, the computers or servers may be considered part of a cloud computing environment. In one embodiment, the cloud computing system may receive data inputs, whether through the internet or other wireless or wired transmission protocol from the robotic devices. In some embodiments, the cloud computing system may transmit data directly to the robotic devices or to an intermediary service which may then relay the information to the robotic devices.

In embodiments, the cloud computing system may issue an instruction or a set of instructions to a single robotic device or local computing device, which may in turn relay the information to one or more other local computing devices and/or robotic devices. In some embodiments, the local computing device and/or robotic device may relay information to other robotic devices, optionally processing and storing input and output data prior to, during, and/or after communication with the cloud computing system. In this embodiment, the robotic device may serve as a single point of long-distance communication with the cloud computing system and may be enabled with short-distance protocols such as Bluetooth® on-board the robotic device.

In accordance with at least one embodiment of the present invention, a computer-implemented method for determining actions intended for use in robotics hardware is presented. The method includes sensing first information from a sensor in a robotic device, transmitting the first information from the robotic device to a first computing device, processing the first information to generate second information and transmitting the second information to one or more robotic devices that are different from the original robotic device. The method further includes sharing first information in the form of training data between the robotic devices to influence a decision model capable of coordinating actions between the robotic devices to accomplish a single goal.

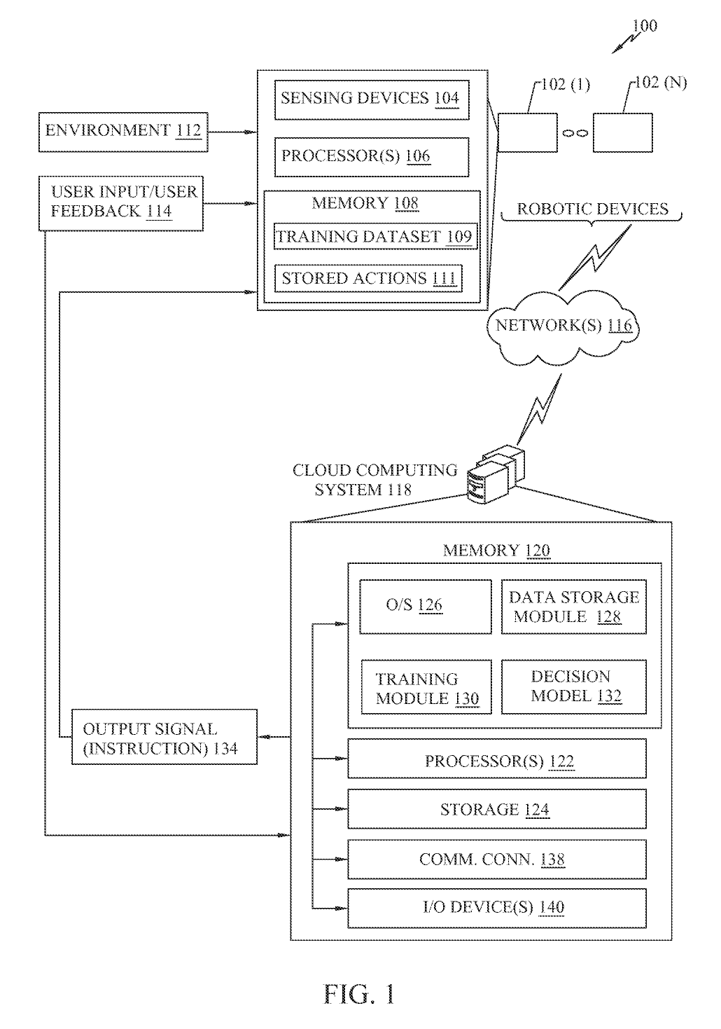

FIG. 1 is an illustrative system or architecture 100 depicting one or more robotic devices interacting with a cloud computing device, in accordance with one embodiment of the present invention. In architecture 100, robotic devices 102(1)-(N) (collectively referred to herein as robotic devices 102) may interact with a cloud computing system 118 via one or more networks 116. In some examples, the networks 116 may include any one or a combination of many different types of networks, such as cable networks, the Internet, wireless networks, cellular networks and other private and/or public networks.

In one embodiment, the cloud computing system 118 may be any type of computing device such as, but not limited to, a mobile phone, a smart phone, a personal digital assistant (PDA), a laptop computer, a desktop computer, a server computer, a thin-client device, a tablet PC, etc. Additionally, it should be noted that in some embodiments, the cloud computing system 118 may be executed by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment. In some examples, the cloud computing system 118 may be in communication with the robotic computing devices 102 and/or other devices via the networks 116, or via other network connections. The cloud computing system 118 may include one or more servers, perhaps arranged in a cluster, as a server farm, or as individual servers as part of an integrated, distributed computing environment.

In one illustrative configuration, the robotic devices 102 may include one or more sensing devices 104, one or more processing units (or processor(s)) 106 and a memory 108. The processor(s) 106 may be implemented as appropriate in hardware, computer-executable instructions, firmware, or combinations thereof. Computer-executable instruction or firmware implementations of the processor(s) 106 may include computer-executable or machine-executable instructions written in any suitable programming language to perform the various functions described.

The memory 108 may store program instructions that are loadable and executable on the processor(s) 106, as well as data generated during the execution of these programs. Depending on the configuration and type of robotic device 102, the memory 108 may be volatile (such as random access memory (RAM)) and/or non-volatile (such as read-only memory (ROM), flash memory, etc.). The robotic device 102 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the robotic devices. In some implementations, the memory 108 may include multiple different types of memory, such as static random access memory (SRAM), dynamic random access memory (DRAM), or non-transitory data storage on ROM.

In one embodiment, the sensing devices 104 may include one or more sensors configured to detect input from the robotic devices 102, from the physical environment 112 or from a user 114 operating the robotic computing device 102. In some examples, the types of input detected by the sensing devices 104 may include, without limitation, global positioning system (GPS) location data, mobile cell phone tower location data, acceleration data, distance measurements, ambient light inputs, video inputs, audio inputs, button inputs, information about other devices nearby the robotic computing devices 102 such as radio-frequency identification (RFID) signals, and the like.

In some embodiments, the output from the sensing devices 104 may include a plurality of sensor readings or measurements. The sensor measurements (received via user input 114, or resulting from the robotic device's autonomous or human-controlled or directed actions or as a result of environmental interaction 112) are then transmitted to the cloud computing system 118. In one embodiment, the sensor measurements may either be processed or transmitted directly as ‘raw data’ from the robotic device 102 to the cloud computing device 118. In another example, the sensor readings, whether raw or processed, may first be transmitted to an intermediate device, which then transmits the information to the cloud computing device 118. In some embodiments, the sensing device 104 may acquire the sensor readings through any combination of hardware including, but not limited to, one or more radar receivers, sonar receivers, laser receivers, servo/motor resistance, switches, joysticks, barometric pressure sensors, capacitive touch sensors, accelerometers, infrared receivers, knobs, light sensors, tilt sensors, or magnetometers. In other embodiments, the sensor readings may be acquired through software, such as by a user typing instructions to the robotic device through a separate computing device, which in turn transmits the instructions to the robotic device.

In accordance with at least one embodiment, the cloud computing system 118 may be configured to receive the sensor data measurements from the robotic devices 102(1)-(N), process the data measurements, generate one or more hardware instructions based on the processed data measurements and transmit the generated hardware instructions to the robotic computing devices. In some embodiments, the cloud computing system 118 may also provide computing resources such as, but not limited to, the data storage, data access and data management of data measurements received from the robotic computing devices 102(1)-(N).

In one illustrative configuration, the cloud computing system 118 may include at least one memory 120 and one or more processing units (or processor(s)) 122. The processor(s) 122 may be implemented as appropriate in hardware, computer-executable instructions, firmware, or combinations thereof. Computer-executable instruction or firmware implementations of the processor(s) 122 may include computer-executable or machine-executable instructions written in any suitable programming language to perform the various functions described.

Processors may be defined as any hardware which accepts electrical signals as input and returns an expected, desired, or predictable output. In one embodiment, processors 122 may include one or multiple general-purpose computer processing units (CPUs) independent of architecture or design, including but not limited to x86, ARM, and quantum-based architectures; graphics processing units, such as those produced by Nvidia® (GPUs); field programmable gate arrays (FPGAs) and application specific integrated circuits (ASICs).

The memory 120 may store program instructions that are loadable and executable on the processor(s) 122, as well as data generated during the execution of these programs. Depending on the configuration and type of cloud computing system 118, the memory 120 may be volatile (such as RAM) and/or non-volatile (such as non-transitory ROM, flash memory, etc.). The cloud computing system 118 may also include additional storage 124, which may include removable storage and/or non-removable storage. The additional storage 124 may include, but is not limited to, magnetic storage, optical disks and/or tape storage. The disk drives and their associated computer-readable media may provide non-volatile storage of computer-readable instructions, data structures, program modules and other data for the computing devices. In some implementations, the memory 120 may include multiple different types of memory, such as SRAM, DRAM, or ROM. Turning to the contents of the memory 120 in more detail and will be described in further detail below, the memory 120 may include an operating system 126, a data storage module 128, a training module 130 and a decision model 132.

In some embodiments, the cloud computing system 118 may be configured to receive data measurements from the robotic devices 102 and store the data measurements in the data storage module 128. In one embodiment, the training module 130 may be configured to process the data measurements stored in the data storage module 120 to generate a training data set. In some examples, the training data set may include a collection of media (images, videos, text, etc.) and/or sensor readings (temperature, velocity, etc.) where each piece of media or grouped pieces of media are associated with some other form or forms of information, such as positive/negative reinforcement and/or metadata. The metadata, for example, may include raw input data from the sensing device 104. The raw sensor input data readings may themselves act as metadata associated with other sensor inputs, media, or recorded interactions. Examples of metadata may also include locations, compass headings, and higher-level knowledge of a situation or object in question, such as context provided by a user. Metadata may be derived contextually from sensor inputs, and it may be accessed from data storage sources on-board the robotic computing devices 102 or from within the cloud computing system 118.

In some embodiments, the training dataset may be updated through the autonomous action of the robotic device; by non-activity, such as a time-based feedback mechanism; or based on manual user feedback mechanisms. In one embodiment, a partial training data set 109 may exist on the robotic device 102 in a form of data storage, which may be cached in memory 108 or stored for long-term purposes in a data storage system. In another embodiment, the training dataset may exist in the cloud computing system 118 and not stored onboard the robotic device 102. In other embodiments, the training data set may exist onboard the robotic device 102 and may later be transferred to the cloud computing system 118 after some established delay or trigger, such as time, location, or completion of a task, to be shared with other robotic devices 102.

In accordance with at least one embodiment, the cloud computing system 118 may include a decision model 132. The decision model 132 may be configured to process the training dataset from the training module 130 to generate an output signal 134. In one embodiment, the decision model 132 may be configured to obtain sensor or contextual inputs from the training data set to generate the output signal 132. In one example, the decision model 114 may apply the training dataset in an original form, i.e. as raw images and distance measurements, or in a derived or synthesized form, such as, for example, by processing a set of rules, for example such as for given hardware instruction A, perform action Y.

In one embodiment, the output signal 134 may include a hardware instruction transmitted to the robotic device 102. The hardware instruction may include, for example, an instruction to the robotic device 102 to apply increased voltage to a specific pin in the controller of the robotic device 102. In one embodiment, the hardware instruction that is output from the decision model 132 may take the form of one or more Boolean values, integers, floats, doubles, or other form of number or text, including arrays of characters or strings, as well as custom data types in the form of structures or instances of classes in the form of objects.

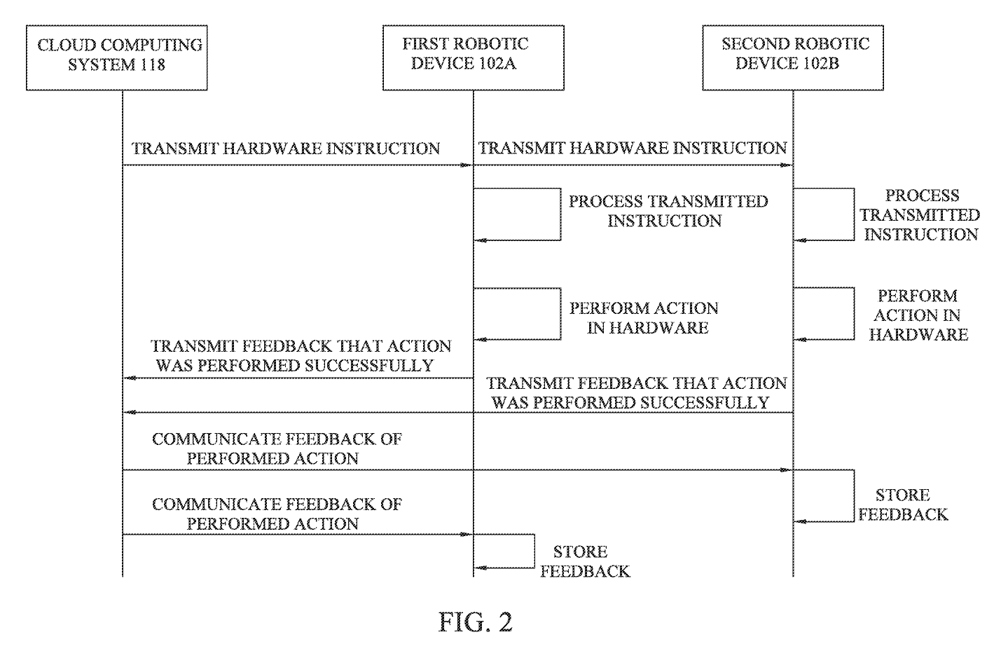

In some embodiments, the robotic device 102 may be configured to perform an action based on the hardware instruction transmitted by the cloud computing system 118. As an example, an action performed by the robotic device may include pushing a heavy block with the cooperation of two, unique robotic devices, applying a greater voltage to a pin in the robotic device, and the like. In one embodiment, the robotic device 102 may be configured to store the performed actions 111 in memory 108. In one embodiment, the robotic device 102 may be configured to share the performed action 111 with one or more other robotic devices 102. Thus, in certain embodiments, the cloud computing system 118 may enable the coordination of actions between the robotic devices 102 to accomplish a single goal. FIG. 2 depicts an example sequence diagram of the steps performed by the cloud computing system to share feedback of an action performed by a robotic device with one or more other robotic devices.

In certain embodiments, the hardware components of the robotic devices 102 may differ. In one embodiment, the cloud computing system 118 is aware of the unique hardware configurations of each robotic device 102 and sends unique instructions to each robotic device to accomplish some shared or single action, e.g. pushing a heavy block with the cooperation of two, unique robotic devices. In one embodiment, given the knowledge of the hardware configuration, these instructions may be “low-level” instructions, directly controlling hardware, e.g. with instructions for voltage applied to specific pins on a controller of the robotic device 102. In another embodiment, the cloud computing system 118 may be unaware of the difference between the hardware configurations between the robotic devices 102. In this situation, the decision model 132 may output “high-level” instructions, e.g. push the block, which are transmitted to the robots, and each robot processes the instruction on-board or with nearby processors, which exist outside the cloud computing device 118 to translate the high-level instruction to specific low-level actions given the robotic device's processor's own knowledge of its hardware configuration, e.g. apply a greater voltage to the servo on a pin (e.g., pin 8).

In one embodiment, user feedback 114 is transmitted from the robotic device 102 to the cloud computing device 118 after the output signal 134 (e.g., a directed hardware action) transmitted from the cloud computing system 118 has been performed or attempted by the robotic device 102. The user feedback 114 may include results measured or collected after performing or while performing the directed action. The results may be classified, for instance as positive, negative, or neutral, using any existing classification algorithm, such as Bayesian Classification, or other algorithms or implementations, such as neural networks, prior to transmitting feedback to the cloud computing system 118. In another embodiment, the results may be classified by a human prior to transmitting feedback to the cloud computing system 118. In another embodiment, the results may be classified by a human after transmitting feedback to the cloud computing system 118. In another embodiment, the results may not be classified at all and may be sent, stored, and accessed in a raw or processed but unclassified format.

In one embodiment, the decision model 132 may include one or more algorithms, formulas, and/or statistical analysis with calculations performed in software through compiled or just-in-time (JIT) machine-understandable code, or directly performed in hardware with integrated circuits. In certain embodiments, a user may also update the training dataset stored in the cloud computing device 118 by providing user feedback 136. In other embodiments, a user may update the training data set stored locally in the robotic device 102 which may then be transmitted to the cloud computing system 118. In one embodiment, the user feedback 114 related to the training dataset may be delivered through web requests using the Hypertext Transfer Protocol (HTTP) or Hypertext Transfer Protocol Secure (HTTPS).

In some embodiments, the cloud computing system 118 may also include communications connection(s) 138 that allow the cloud computing device 118 to communicate with a stored database, another computing device or server, user terminals and/or other devices on the networks 116. The cloud computing device 118 may also include I/O device(s) 140, such as a keyboard, a mouse, a pen, a voice input device, a touch input device, a display, speakers, a printer, etc.

FIG. 2 depicts an example sequence diagram of the steps performed by the cloud computing system to communicate feedback of an action performed by a robotic device to one or more other robotic devices, in accordance with one embodiment of the present invention. The sequence diagram depicted in FIG. 2 is only an example and is not intended to be limiting. In one example, the steps performed by the cloud computing system 118 maybe as follows:
(1) The cloud computing system 118 transmits an output signal (e.g., a hardware instruction) to a first robotic device 102A and a second robotic device 102B.
(2) The first robotic device 102A and the second robotic device 102B process the transmitted instruction and perform one or more actions in response to the transmitted instruction.
(3) The first robotic device 102A and the second computing device 102B transmit feedback to the cloud computing system 118 that the actions were performed successfully.
(4) The cloud computing system 118 communicates the feedback of the performed action received from the first robotic device 102A to the second robotic device 102B. In one embodiment, the performed action may be stored as training data in the second robotic device 102B. In some embodiments, the second robotic device 102B may be configured to update its training dataset (e.g., 109) to include this stored action. Accordingly, the cloud computing system 118 may enable the coordination of actions between the robotic devices 102A and 102B to accomplish a single goal.
(5) The cloud computing system 118 communicates the feedback of the performed action received from the second robotic device 102B to the first robotic device 102A. In one embodiment, the performed action may be stored as training data in the first robotic device 102A. In some embodiments, the first robotic device 102A may be configured to update its training dataset (e.g., 109) to include this stored action. Accordingly, the cloud computing system 118 may enable the coordination of actions between the robotic devices 102A and 102B to accomplish a single goal.

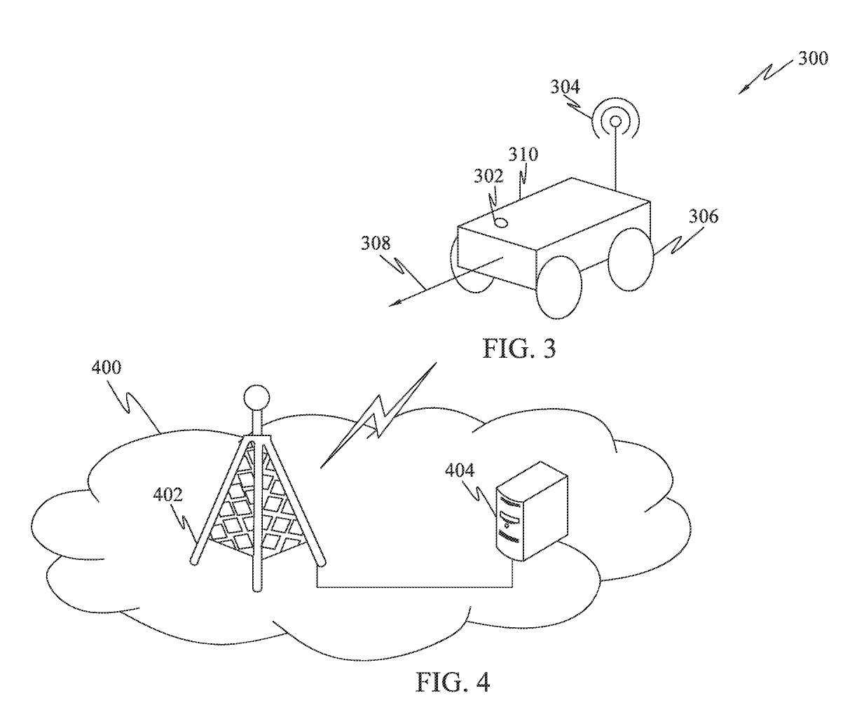

FIG. 3 is a simplified block diagram of a robotic device 300, in accordance with one embodiment of the present invention. In one embodiment, the robotic device 300 may include one or more sensors 302 such as location, orientation, gravimetric and/or acceleration sensors and a wireless radio transceiver 304. In one embodiment, the wireless radio transceiver 304 may operate on low bandwidth, power saving radio transmission standards such as Bluetooth®, 6LoWPAN®, ZigBee®, DASH7®, Z-Wave®, MiWi®, or OSION®. In another embodiment, the wireless radio transceiver may operate WiFi®, or cellular radio transmission standards. In accordance with at least one embodiment, the robotic device 300 may perform a desired action in response to receiving an instruction from the cloud computing system as discussed in detail in relation to FIG. 1. In some examples, the desired actions may include applying a voltage to the servo motor 310, moving the wheels 306, forward propelling the robotic device 308, and the like.

FIG. 4 is a simplified block diagram of a world-wide-web or cloud network 400 linked to the robotic computing device represented in FIG. 3, in accordance with one embodiment of the present invention. FIG. 4 shows a base station 402 for sending or receiving cellular or WiFi® radio transmission to or from robotic device 300, respectively. Base station 402 may be coupled to one or more server computing devices 404. In one embodiment, the server computing devices 404 may be located in different locations or in multiple clouds.

### Exemplary Implementation of a Decision Model in the Cloud Computing System

In one embodiment, the decision model 132 in the cloud computing system 118 may be implemented as a supervised learning model. As an example, a supervised learning model may be a support vector machine (SVM). In one example, an SVM training algorithm is disclosed that performs the classification of training datasets and the recognition of patterns for sensor inputs in the training data sets. The SVM training algorithm is discussed in detail below.

In one implementation, given a training dataset, each marked as belonging to one of two categories, an SVM training algorithm builds a model that assigns new training dataset examples into one category or the other, making it a non-probabilistic binary linear classifier. As described herein, an SVM model is a representation of the examples as points in space, mapped so that the examples of the separate categories are divided by a clear gap that is as wide as possible. New examples may then be mapped into that same space and predicted to belong to a category based on which side of the gap they fall on.

Given training data [symbol] , a set of n points may be expressed as follows:

[symbol]

={(xᵢ,yᵢ)|xᵢε [symbol] ^{p},yᵢε{−1,1}}ᵢ₌₁ⁿ

where yᵢ is either 1 or −1 and indicates the class to which the point xᵢ belongs. Each xᵢ is a p-dimensional real vector. In one embodiment, the maximum-margin hyperplane that divides the points having yᵢ=1 from those having yᵢ=−1 may be determined.

In one example, a hyperplane may be represented as the set of points x satisfying the condition:

w·x−b=0.

where . denotes the dot product and w the (not necessarily normalized) normal vector to the hyperplane. The parameter

$$\frac{2}{‖ w ‖} ,$$

determines the offset of the hyperplane from the origin along the normal vector W.

If the training data in the training data set is determined to be linearly separable, then, in one embodiment, two hyperplanes may be selected such that they separate the data and there are no points between them, and then the hyperplanes are selected to maximize their distance. The region bounded by them may be called “the margin”. In one example, these hyperplanes may be described by the equations:

w·x−b=1

and

w·x−b=−1.

By using geometry, the distance between these two hyperplanes determined to be

$$\frac{2}{‖ w ‖} ,$$

∥w∥ is minimized. As data points need to be prevented from falling into the margin, in one example, the following constraint may be added: for each i either

w·xᵢ−b≧1 for xᵢ of the first class

or

w·xᵢ−b≦−1 for xᵢ of the second.

This may be rewritten as:

yᵢ(w·x−b)≧1, for all 1≦i≦n. (1)

The above example may be stated as an optimization problem as follows:

### Minimize (in w, b)

∥w∥
subject to (for any i=1, . . . , n)

yᵢ(w·xᵢ−b)≧1.

If the equation arrived at above is re-written into its primal form, the optimization problem presented in the preceding section depends on ∥w∥, the norm of w, which involves a square root. In one example, the equation may be altered by substituting ∥w∥ with ½∥w∥² (the factor of ½ being used for mathematical convenience) without changing the solution (the minimum of the original and the modified equation have the same w and b). In one example, this may be defined as a quadratic programming optimization problem, which may be stated as follows: clearly:

$$arg {min}_{( w , b )} \frac{1}{2} {‖ w ‖}^{2}$$

subject to (for any i=1, . . . , n)

yᵢ(w·xᵢ−b)≧1.

By introducing Lagrange multipliers α, the previous constrained problem may be expressed as

$$arg {min}_{w , b} {max}_{α \geq 0} \{ \frac{1}{2} {‖ w ‖}^{2} - {\sum }_{i = 1}^{n} {α}_{i} [ {y}_{i} ( w \cdot {x}_{i} - b ) - 1 ] \}$$

Based on identifying a saddle point, all the points which can be separated as yᵢ(w·xᵢ−b)−1>0 do not matter since the corresponding αᵢ are set to zero.

In one example, this situation may be solved by standard quadratic programming techniques and programs. In one example, a “stationary” Karush-Kuhn-Tucker condition may be applied that implies that the solution may be expressed as a linear combination of the training vectors:

$$w = {\sum }_{i = 1}^{n} {α}_{i} {y}_{i} {x}_{i} .$$

Only a few αᵢ will be greater than zero. The corresponding xᵢ are exactly the support vectors, which lie on the margin and satisfy yᵢ(w·xᵢ−b)=1. From this, it may be derived that the support vectors also satisfy the following condition:

w·xᵢ−b=1/yᵢ=yᵢ [symbol] b=w·xᵢ−yᵢ

Which enables the definition of the offset b. In practice, it is more robust to average over all N_{SV} support vectors as follows:

$$b = \frac{1}{{N}_{SV}} {\sum }_{i = 1}^{{N}_{SV}} ( w \cdot {x}_{i} - {y}_{i} )$$

Writing the classification rule in its unconstrained dual form reveals that the maximum-margin hyperplane and therefore the classification task is a function of the support vectors, the subset of the training data that lie on the margin.

Using the fact that ∥w∥²=w·w and substituting,

$$w = {\sum }_{i = 1}^{n} {α}_{i} {y}_{i} {x}_{i} ,$$

it can be shown that the dual of the SVM reduces to the following optimization problem:
Maximize (in αᵢ)

$$\tilde{L} ( α ) = {\sum }_{i = 1}^{n} {α}_{i} - \frac{1}{2} {\sum }_{i , j} {α}_{i} {α}_{j} {y}_{i} {y}_{j} {x}_{i}^{T} {x}_{j} = {\sum }_{i = 1}^{n} {α}_{i} - \frac{1}{2} {\sum }_{i , j} {α}_{i} {α}_{j} {y}_{i} {y}_{j} k ( {x}_{i} , {x}_{j} )$$

subject to (for any i=1, . . . , n)
αᵢ≧0,
and to the constraint from the minimization in b

$${\sum }_{i = 1}^{n} {α}_{i} {y}_{i} = 0.$$

Here the kernel is defined by k(xᵢ, xⱼ)=xᵢ·xⱼ.

W can be computed based on the α terms:

$$w = {\sum }_{i} {α}_{i} {y}_{i} {x}_{i} .$$

In some examples, it may be required to pass the hyperplane through the origin of the coordinate system. Such hyperplanes may be referred to as unbiased, whereas general hyperplanes not necessarily passing through the origin may be referred to as biased. An unbiased hyperplane can be enforced by setting b=0 in the primal optimization problem. The corresponding dual is identical to the dual given above without the equality constraint as shown below:

$${\sum }_{i = 1}^{n} {α}_{i} {y}_{i} = 0$$

If there exists no hyperplane that can split the “yes” and “no” examples, the Soft Margin method may be applied that chooses a hyperplane that splits the examples, while still maximizing the distance to the nearest split examples. The method may introduce non-negative slack variables, ξᵢ, which measure the degree of misclassification of the data χᵢ

yᵢ(w·xᵢ−b)≧1−ξᵢ1≦i≦n. (2)

The objective function may then be increased by a function which penalizes non-zero ξᵢ, and the optimization becomes a trade-off between a large margin and a small error penalty. If the penalty function is linear, the optimization problem may be stated as shown below:

$$arg {min}_{w , ξ , b} \{ \frac{1}{2} {‖ w ‖}^{2} + C {\sum }_{i = 1}^{n} {ξ}_{i} \}$$

subject to (for any i=1, . . . n)

yᵢ(w·xᵢ−b)≧1−ξᵢ,ξᵢ≧0

This constraint in (2) along with the objective of minimizing ∥w∥ may be solved using Lagrange multipliers as shown above. The following problem may then be solved as follows:

$$arg {min}_{w , ξ , b} {max}_{α , β} \{ \frac{1}{2} {‖ w ‖}^{2} + C {\sum }_{i = 1}^{n} {ξ}_{i} - {\sum }_{i = 1}^{n} {α}_{i} [ {y}_{i} ( w \cdot {x}_{i} - b ) - 1 + {ξ}_{i} ] - {\sum }_{i = 1}^{n} {β}_{i} {ξ}_{i} \}$$

with αᵢ, βᵢ≧0.

The above equation can be expressed in its dual form through the following steps:

Maximize (in αᵢ)

$$\tilde{L} ( α ) = {\sum }_{i = 1}^{n} {α}_{i} - \frac{1}{2} {\sum }_{i , j} {α}_{i} {α}_{j} {y}_{i} {y}_{j} k ( {x}_{i} , {x}_{j} )$$

subject to (for any i=1, . . . , n)

0≦αᵢ≦C,

and

$${\sum }_{i = 1}^{n} {α}_{i} {y}_{i} = 0.$$

One advantage of using a linear penalty function is that the slack variables vanish from the dual problem, with the constant C appearing only as an additional constraint on the Lagrange multipliers. Nonlinear penalty functions have been used, particularly to reduce the effect of outliers on the classifier, but unless care is taken the problem becomes non-convex, and thus it is considerably complex to find a global solution.

As a margin classifier, its generalization error may be bound by parameters of the algorithm and a margin term. An example of such a bound is for the AdaBoost algorithm. Let S be a set of m examples sampled independently at random from a distribution D. Assume the VC-dimension of the underlying base classifier is d and m≧d≧1. Then with probability 1−δ we have the bound as defined below:

$${P}_{D} ( \frac{y {\sum }_{j}^{i} {α}_{j} {h}_{j} ( x )}{\sum \vert {α}_{j} \vert} \leq 0 ) \leq {P}_{S} ( \frac{y {\sum }_{j}^{t} {α}_{j} {h}_{j} ( x )}{\sum \vert {α}_{j} \vert} \leq θ ) + O ( \frac{1}{\sqrt{m}} \sqrt{d {log}^{2} ( m / d ) / {θ}^{2} + log ( 1 / δ )} )$$

for all θ>0.

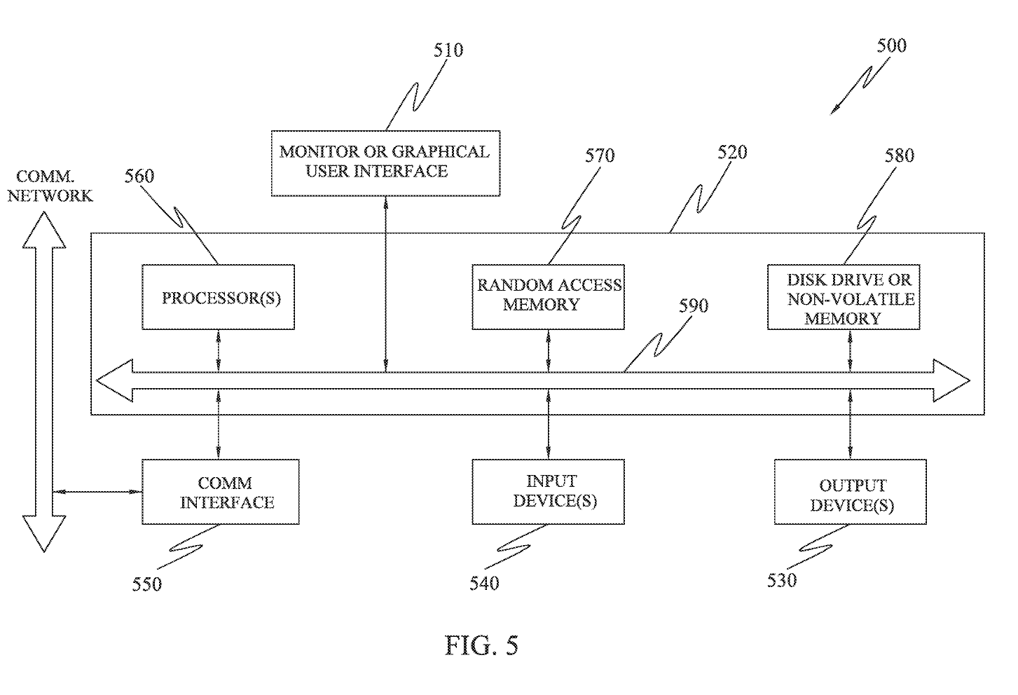

FIG. 5 depicts a simplified block diagram of a computer system that may incorporate embodiments of the present invention. FIG. 5 is merely illustrative of an embodiment incorporating the present invention and does not limit the scope of the invention as recited in the claims. One of ordinary skill in the art would recognize other variations, modifications, and alternatives.

In one embodiment, computer system 500 typically includes a monitor or graphical user interface 510, a computer 520, user output devices 530, user input devices 540, communications interface 550, and the like. Computer system 500 may also be a smart phone, tablet-computing device, and the like, such that the boundary of computer 520 may enclose monitor or graphical user interface 510, user output devices 530, user input devices 540, and/or communications interface 550 (not shown).

As depicted in FIG. 5, computer 520 may include a processor(s) 560 that communicates with a number of peripheral devices via a bus subsystem 590. These peripheral devices may include user output devices 530, user input devices 540, communications interface 550, and a storage subsystem, such as random access memory (RAM) 570 and disk drive or non-volatile memory 580.

User input devices 530 include all possible types of devices and mechanisms for inputting information to computer system 520. These may include a keyboard, a keypad, a touch screen incorporated into the display, audio input devices such as voice recognition systems, microphones, and other types of input devices. In various embodiments, user input devices 530 are typically embodied as a computer mouse, a trackball, a track pad, a joystick, wireless remote, drawing tablet, voice command system, eye tracking system, and the like. User input devices 530 typically allow a user to select objects, icons, text and the like that appear on the monitor or graphical user interface 510 via a command such as a click of a button, touch of the display screen, or the like.

User output devices 540 include all possible types of devices and mechanisms for outputting information from computer 520. These may include a display (e.g., monitor or graphical user interface 510), non-visual displays such as audio output devices, etc.

Communications interface 550 provides an interface to other communication networks and devices. Communications interface 550 may serve as an interface for receiving data from and transmitting data to other systems. Embodiments of communications interface 550 typically include an Ethernet card, a modem (telephone, satellite, cable, ISDN), (asynchronous) digital subscriber line (DSL) unit, FireWire interface, USB interface, and the like. For example, communications interface 550 may be coupled to a computer network, to a FireWire bus, or the like. In other embodiments, communications interfaces 550 may be physically integrated on the motherboard of computer 520, and may be a software program, such as soft DSL, or the like. Embodiments of communications interface 550 may also include a wireless radio transceiver using radio transmission protocols such as Bluetooth®, WiFi®, cellular, and the like.

In various embodiments, computer system 500 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiment, computer 520 includes one or more Xeon microprocessors from Intel as processor(s) 560. Further, one embodiment, computer 520 includes a UNIX-based operating system. In another embodiment, the processor may be included in an applications processor or part of a system on a chip.

RAM 570 and disk drive or non-volatile memory 580 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 570 and disk drive or non-volatile memory 580 may be configured to store the basic programming and data constructs that provide the functionality of the present invention.

Software code modules and instructions that provide the functionality of the present invention may be stored in RAM 570 and disk drive or non-volatile memory 580. These software modules may be executed by processor(s) 560. RAM 570 and disk drive or non-volatile memory 580 may also provide a repository for storing data used in accordance with the present invention.

RAM 570 and disk drive or non-volatile memory 580 may include a number of memories including a main random access memory (RAM) for storage of instructions and data during program execution and a read only memory (ROM) in which fixed instructions are stored. RAM 570 and disk drive or non-volatile memory 580 may include a file storage subsystem providing persistent (non-volatile) storage for program and data files. RAM 570 and disk drive or non-volatile memory 580 may also include removable storage systems, such as removable flash memory.

Bus subsystem 590 provides a mechanism for letting the various components and subsystems of computer 520 communicate with each other as intended. Although bus subsystem 590 is shown schematically as a single bus, alternative embodiments of the bus subsystem may utilize multiple busses.

FIG. 5 is representative of a computer system capable of embodying a portion of the present invention. It will be readily apparent to one of ordinary skill in the art that many other hardware and software configurations are suitable for use with the present invention. For example, the computer may be a desktop, laptop, portable, rack-mounted, smart phone or tablet configuration. Additionally, the computer may be a series of networked computers. Further, the use of other microprocessors are contemplated, such as Pentium™ or Itanium™ microprocessors; Opteron™ or AthlonXP™ microprocessors from Advanced Micro Devices, Inc; embedded processors such as ARM® licensed from ARM® Holdings plc., and the like. Further, other types of operating systems are contemplated, such as Windows®, WindowsXP®, WindowsNT®, WindowsRT® or the like from Microsoft Corporation, Solaris from Sun Microsystems, LINUX, UNIX, or mobile operating systems such as Android® from Google Inc., iOS® from Apple Inc., Symbion® from Nokia Corp., and the like. In still other embodiments, the techniques described above may be implemented upon a chip or an auxiliary processing board.

Various embodiments of the present invention can be implemented in the form of logic in software or hardware or a combination of both. The logic may be stored in a computer readable or machine-readable non-transitory storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The above embodiments of the present invention are illustrative and not limiting. The above embodiments of the present invention may be combined, in one or multiple combinations, as various alternatives and equivalents are possible. Although, the invention has been described with reference to a wearable-computing device such as a smart-watch by way of an example, it is understood that the invention is not limited by the type of wearable device. Although, the invention has been described with reference to certain radio communications interface by way of an example, it is understood that the invention is not limited by the type of radio, wireless, or wired communications interface. Although, the invention has been described with reference to certain operating systems by way of an example, it is understood that the invention is not limited by the type of operating systems. Other additions, subtractions, or modifications are obvious in view of the present disclosure and are intended to fall within the scope of the appended claims.

What is claimed is:

1. A computer-implemented method for producing an output from an input or inputs, the method comprising:
sensing first information from a sensor in a first robotic device;
transmitting the first information to a first computing device;
receiving resulting information from the first computing device based at least in part on the first information;
determining, in response to the resulting information, at least one of a hardware instruction or one or more actions to be performed by the robotic device;
performing the one or more actions; and
storing the one or more actions.

2. The computer-implemented method of claim 1, further comprising communicating feedback regarding the one or more performed actions to one or more additional robotic devices that are different from the first robotic device.

3. The computer-implemented method of claim 2, further comprising coordinating of actions between the first robotic device and the one or more additional robotic devices to accomplish a single goal.

4. The computer-implemented method of claim 1, further comprising storing actions performed by the first robotic device and one or more additional robotic devices as training data sets, wherein the training data sets are shared between two or more robotic devices.

5. The computer-implemented method of claim 4, further comprising influencing, using the training data sets, at least one decision model capable of coordinating actions between the robotic devices to accomplish a single goal.

6. The computer-implemented method of claim 1, further comprising:
generating second information based at least in part on the first information; and
transmitting the second information to one or more additional robotic devices that are different from the first robotic device.

7. The computer-implemented method of claim 1, further comprising transmitting low level instructions to the first robotic device, wherein the low level instructions are for directly controlling hardware of the first robotic device.

8. The computer-implemented method of claim 1, further comprising:
transmitting high level instructions to the first robotic device or a computing device, which is in vicinity of the first robotic device; and
converting the high level instructions into low level instructions by the first robotic device or the computing device, which is in the vicinity of the first robotic device, wherein the low level instructions are instructions for directly controlling hardware of the first robotic device.

9. A system for producing a real-time stream of information associated with inputs from one or more portable-computing devices, the system comprising:
a first processor in a first portable-computing device;
a second processor in a computing device; and
a memory storing a set of instructions which when executed by the first processor and the second processor configures:
the first processor to sense first information from a sensor in the first portable-computing device;
the second processor to process the first information in the computing device to generate processed information;
the second processor to transmit the processed information to the first portable-computing device;
the first processor to transmit feedback of an action performed by the first portable-computing device based at least in part on the processed information to the computing device; and
the second processor to communicate the feedback to a second portable-computing device, the second portable-computing device being different from the first portable-computing device.

10. The system of claim 9, wherein the instructions which when executed by the second processor configures the second processor to coordinate actions between the first portable-computing device and the second portable-computing device to accomplish a single goal.

11. The system of claim 9, wherein the memory stores actions performed by the first portable-computing device as training data set, wherein the instructions which when executed by at least one of the first processor and the second processor configures at least one of the first processor and the second processor to share at least a part of the training data set between the first portable-computing device and the second portable-computing device.

12. The system of claim 11, wherein the training data set comprises at least one of media and sensor readings.

13. The system of claim 12, wherein each of the media and the sensor readings is associated with at least one of positive or negative reinforcement and metadata.

14. The system of claim 9, wherein the memory stores actions performed by the first portable-computing device as training data set, wherein the instructions which when executed by the first processor configures the first processor to update the training dataset in the first portable-computing device based at least in part on the action to generate an updated training data set.

15. The system of claim 9, wherein the instructions which when executed by the second processor configures the second processor to generate second information based at least in part on the first information and transmit at least a part of the second information to the second portable-computing device.

16. The system of claim 9, wherein the instructions which when executed by the second processor configures the second processor to transmit instructions for directly controlling hardware of the first portable-computing device.

17. The system of claim 9, wherein the instructions which when executed by the first processor and the second processor configures:
the second processor to transmit high level instructions corresponding to the first portable-computing device; and
the first processor to determine low level instructions based at least in part on the high level instructions and hardware configuration of the first portable-computing device for controlling hardware of the first portable-computing device.

18. A non-transitory computer-readable medium storing computer-executable code for producing a real-time stream of information associated with inputs from a portable-computing device, the non-transitory computer-readable medium comprising:
code for sensing first information from one or more sensors in one or more robotic devices;
code for transmitting the first information to a computing device;
code for receiving processed information from the computing device based at least on part on the first information, the processed information including one or more hardware instructions to be performed by the one or more robotic devices;
code for performing one or more actions by the one or more robotic devices, based at least in part on the one or more hardware instructions;
code for transmitting the one or more actions to the computing device.

19. A computer-implemented method comprising:
sensing information using one or more sensors in a first robotic device;
transmitting the information to a computing device;
receiving processed information from the computing device;
performing a hardware action in the first robotic device based at least in part on the processed information; and
enabling communication of feedback of the hardware action to a second robotic device, the second robotic device being different from the first robotic device;

20. A computer-implemented method for producing an output from an input or inputs, the method comprising:
sensing information using one or more sensors in a first robotic device;
transmitting the information to a computing device;
receiving processed information from the computing device;
performing a hardware action in the first robotic device based at least in part on the processed information;
transmitting the hardware action to the computing device;
enabling communication of feedback of the hardware action to a second robotic device, the second robotic device being different from the first robotic device;
updating a training dataset in the first robotic device based at least in part on the hardware action to generate an updated training dataset; and
enabling communication of the updated training dataset to the second robotic device.
